(19) United States
(12) Patent Application Publication
(10) Pub. No.: US 2019/0259008 A1
(43) Pub. Date: Aug. 22, 2019

(54) System and Method of Indexing Websites Using Contextually Unique Domain Extensions

(71) Applicant: Stephen Boyd Lindsey, Plano, TX (US)

(72) Inventor: Stephen Boyd Lindsey, Plano, TX (US)

(21) Appl. No.: 16/362,621

(22) Filed: Mar. 23, 2019

Related U.S. Application Data
(63) Continuation-in-part of application No. 15/919,027, filed on Mar. 12, 2018, now abandoned.
(60) Provisional application No. 62/550,697, filed on Aug. 28, 2017.

(51) Int. Cl. G06Q 20/06; H04L 29/12; G06Q 20/22; G06Q 20/38

(52) U.S. Cl. CPC G06Q 20/0658; H04L 61/6004; G06Q 20/12; G06Q 20/3829; G06Q 20/223

(57) ABSTRACT

An online index of websites that leverages generic top-level domain extension names as an intuitive nomenclature with which to index websites using a website template or plug-in. The website template or plug-in and associated software accesses the consolidated data of the indexed websites into a virtual database and synchronizes the data to a user's hardware wallet which operates an exchange software program forming a decentralized exchange enabling transactions to be settled off-line and peer-to-peer which are then recorded onto a distributed ledger or block-chain.

### CROSS-REFERENCE TO RELATED APPLICATIONS

This application takes benefit of U.S. patent application Ser. No. 15/919,027 filed Mar. 12, 2018 which in turn takes benefit of U.S. Provisional Pat. No. 62/550,697 filed Aug. 28, 2017 and hereby incorporates them in their entirety by reference.

### FIELD OF THE INVENTION

An online index of websites that leverages generic top-level domain extension names as an intuitive nomenclature with which to index websites using a website template or plug-in. The website template or plug-in and associated software accesses the consolidated data of the indexed websites into a virtual database and forms a distributed ledger or block-chain enabling transactions to be settled peer-to-peer and off-line on a de-centralized exchange incorporated into a hardware wallet.

### BACKGROUND OF THE INVENTION

A curated online index (“the index”) of user accessible software applications such as websites and mobile software applications (“apps”) that leverages new generic top level domain extension names as an intuitive nomenclature with which to index websites using a website template (also known as a “theme”) or software plug-in to consolidate the data of the indexed websites and apps into a virtual database and distributed ledger or block-chain to enable the user of the index to browse the data in a convenient and intuitive fashion to facilitate a transaction with the indexed website or app in a manner that creates a safer and more efficient online marketplace which settles transactions on a decentralized exchange (or “DEX”) which operates only on a hardware wallet such as a USB device which stores a digital currency, with the ability to reward users financially for their use of the index via a digital currency based on the distributed ledger.

Users of the internet are largely dependent upon algorithm-based search engines such as Google, Bing, and Yahoo to discover the information and resources they seek. This is a highly inefficient method for the user as such software algorithms are easily manipulated by website developers who, armed with knowledge of the algorithm, can construct a website that appears more relevant to the key words of a user's given search term than it actually is thus gaining a higher position or “rank” in the search results produced by that software algorithm.

This can result in pages of useless or only marginally useful information forcing the user to waste a great amount of time and effort to locate the information needed. It also results in exposing the user to dangerous “spam” websites masquerading as legitimate sites that can infect the user's computer with malware and viruses using software cookies, phishing, catfishing, and other tricks. The present invention solves this problem by providing a unique and novel method to evaluate and organize websites into a searchable index that utilizes domain name extensions to create an intuitive index nomenclature and pairs that index nomenclature with intuitive visual iconic symbols to enable the user to rapidly locate the desired information and services provided by sources which can be evaluated and screened for good business practices through the use of a template/theme or a plug-in and a distributed ledger.

Additionally, ICANN, the Internet's domain name caretaker, has recently begun rolling out hundreds of new domain name extensions with the potential for creating more confusion for users of the worldwide web. The present invention “separates the wheat from the chaff” of these new generic top-level domain (“gTLD”) extensions by making use of those extensions that can be deemed intuitive in nature to Internet users as descriptions of information and content. For example, the domain name extension, .gallery, is used for image gallery sites, .directory, for online directories, .guide, for online guides, and so forth.

This will enable both users and developers to more easily take advantage of these new domain name extensions creating new information portals and online marketplaces with more focused and relevant content and services. For example, users looking to purchase used car parts could go to indexter.bid and search the term “car parts” to find an online auction site located at carparts.bid where the user can join an online auction to bid for used car parts. As a website indexed by the present invention, carparts.bid would be linked to the invention's distributed ledger where the site's transactions are recorded as a permanent record on the ledger which can be monitored and evaluated for legality and security.

Furthermore, the transaction records can be used to reward both users and developers for utilizing the index by rewarding them with digital currency which can be used in transactions with sites linked to the index.

The present invention, by its nature, becomes an important online portal that consolidates and distributes internet user traffic making it economically rewarding to develop websites utilizing these new generic top-level domain extensions through the creation of new online marketplaces that share a digital currency.

For example, large e-commerce websites and online marketplaces like amazon.com and ebay.com settle millions of transactions annually by accepting online payments with credit and debit cards, the details of which are stored on databases within these websites. As such, these sites become rich targets for hackers looking to steal the payment and identity information of the users of these sites.

By settling all transactions on a peer-to-peer basis via a decentralized exchange (or “DEX”) which operates only on the hardware wallets of the index users using a distributed ledger or “block chain”, all transactions can be done off-line and anonymously with no identity or personal payment information as associated with credit and debit card numbers stored on a website. Payments are settled on the DEX of each counter-party's hardware wallet using digital currency (which is anonymous in nature) and recorded on the distributed ledger or block chain and users of the invention (the “index”) will receive a digital receipt recorded on the distributed ledger which can be used to initiate returns and refunds.

### BRIEF DESCRIPTION OF THE DRAWINGS

FIG. 1 is a diagram showing the structure of the present invention.

FIG. 2 is an illustration showing the icon bar of the present invention.

FIG. 3 is a diagram showing the details of the hardware wallet.

### DETAILED DESCRIPTION OF THE INVENTION

The present invention is a novel and unique index for websites and apps which utilizes a template, such as a library of related codes such as a WordPress theme or plug-in, designed to be used by websites utilizing the same domain name extension, such as .gallery for image galleries.

The data on these websites and apps can be tagged using a standardized methodology and thus consolidated into a virtual database that can be used to create an online index while creating the opportunity to evaluate the parties utilizing the template by linking transaction histories to a distributed ledger maintained by the index to insure the integrity and security of the user experience. By doing so, it becomes possible to consolidate the data of multiple websites and apps into a single online index taking the form of a website or mobile/PC software application. This website or mobile/PC software application can then be utilized by a user, such as an online marketplace, to facilitate trade more safely and efficiently while allowing the index to reward both users and website developers for the transaction with a dividend paid in the form of a digital currency.

The digital currency, such as Bitcoin, Ethereum, or a proprietary currency, is “mined” (as such term is used by the digital currency industry) by the computers of the users and website developers each time they initiate a command on the index, such as performing a search or making a transaction, clicking on an image, or synchronizing the hardware wallet to the distributed ledger, etc. The execution of this command adds a brief, yet specific, amount of “hashing power” to the mining process for which the user and developer is rewarded. Furthermore, by utilizing a distributed ledger, the index can operate a decentralized exchange (or “DEX”) on the hardware wallets of users, typically constructed as USB devices, enabling payment transactions to be settled both off-line and peer-to-peer instead of relying on merchant processing companies such as banks and stand-alone credit card processors. This results in a significant savings for online retailers as well as creating anonymity for the buyer which prevents their identity and personal financial information from being stolen.

The present invention also incorporates intuitive visual iconic symbols by means of a horizontal bar of icons at the top of each website page appearing in the index. Each icon represents one of the domain name extensions used in the index nomenclature, such as a camera symbol to symbolize the .gallery domain name extension. By clicking on the camera symbol, the user is linked to the website indexter.gallery which acts as the parent directory of the index of .gallery websites. On this page the user can search any term or key word to discover the .gallery websites listed in the index that pertain to that key word or term. For example, a user can type in the term “car” which will produce a list of all gallery websites in the index pertaining to cars such as car.gallery or musclecar.gallery, etc.

Each website listed in the index utilizes the template, such as a special Wordpress Theme, or so-called “Plug-In” published by the operator of the indexter index for websites using the .gallery domain extension. Any user of the index needing to locate images of cars can click on the camera icon in the icon bar (at the top of any web page appearing in the index or any web browser incorporating the icon bar) to be taken to the parent directory of the index for gallery websites (https://www.indexter.gallery) where the user can search the term “car” which will produce a list of all indexed gallery websites related to cars.

Alternately, the user can simply type “indexter.gallery” into the address bar of their web browser to be linked immediately to the .gallery parent directory. The user can also utilize the intuitive nomenclature of the index to simply type “car.gallery” into the same address bar skipping the parent directory all together to go immediately to the desired gallery of car images.

If no such website as car.gallery exists, the user can click the camera symbol on the icon bar (or, if no icon bar is present, type in indexter.gallery into the web browser address bar) to go to the parent directory of .gallery websites. The user then searches the term “car” to access a list of all car related websites using the .gallery domain name extension (or any car website or app using the template) listed in the index. This same unique and novel method of indexing can be applied to .directory websites, .guide websites, .social websites, etc. It is important to note that any user can make use of this index without any special software or non-standard web browser.

The index is easily accessed from any web browser with or without the icon bar and without having any special knowledge of the nomenclature used by the index. This is one of the many reasons the present invention represents a unique and novel approach to searching for information, resources, goods, and services on the internet.

The recent rollout of new generic top level domain extensions (gTLDs) has, out of the hundreds created, included new ones such as .directory for directory websites and .gallery for image gallery websites. Such domain name extensions are intuitive in nature to average web users and can thus be used to form the basis of this new, intuitive nomenclature for domain name extensions. This allows web users to easily locate websites and/or apps without the need of a search engine and enables the creation of a curated online index.

The present invention will utilize a template or “plug-in”, as such term is commonly used in the software trade, created for use by third party developers (the “template”) creating websites (and apps) with specific domain name extensions (or websites and apps with specific areas of trade or interest). An example might be an image gallery WordPress theme designed to be used by websites that use the new .gallery gTLD which website developers can use to upload data, such as images, with standardized descriptive tags. This will allow an online index to easily locate and consolidate (virtually or otherwise) all the data on websites and apps using the same domain name extension and/or template into a single user interface taking the form of an online index accessible on computers and mobile devices such as smart phones.

Apps are included herewith (alongside websites) as software programs that operate from an internet domain name/address. Examples of these are applications downloaded on mobile devices which do little more than open a web browser on the device on which the application runs. Note that Google purchased the .app domain name extension with this purpose in mind.

Users of the index will be able to sort and filter this data based on these descriptive tags, transforming the websites and apps that utilize the same domain name extension and/or the template into compatible databases accessible from a single online index. This brings greater organization to the information stored and accessed by these websites and apps making it possible to create an online marketplace that facilitates trade more efficiently.

Further, by utilizing the template to link these websites to a distributed ledger that records transaction histories, it creates the opportunity to scrutinize the integrity of the developers licensed to use the template to create a safe and more secure online environment for the user.

For example, images posted on websites using the .gallery domain name extension that also utilize the template can be accessed on the index in a manner that allows the images to be searched, sorted, and filtered by the characteristics of the images as if the images resided on a single database. A user may search for images of a dress on the website http://www.dress.gallery using the data tags of “black dress” and “long hem” producing a gallery of dress images matching those descriptive tags and by clicking on the resulting images the user can evaluate the item in more detail without leaving the index then click to be linked to the website which uploaded the image to purchase the dress from that website operator. In this manner, the online index facilitates trade by functioning as an online marketplace displaying products, wares, and services from an unlimited number of websites enabling the user to make a transaction quickly without having to view multiple websites.

The online index will exist on a platform of multiple websites and mobile/PC apps linked together using a set of intuitive symbolic icons that appear as a horizontal bar at the top of web pages and web browsers enabling the user to navigate through the data consolidated by the template or plug-in. For example, a user may see a small icon of a camera to represent the index of online image galleries. The user will be able to click that camera icon to be linked to a website using the domain address of https://www.indexter.gallery (or http://www.begin.gallery) that will allow the user to search the images uploaded by multiple websites using the .gallery domain name extension or for sub-indexes such as hair.gallery or car.gallery.

If the user sees an image on the index and decides to purchase the object featured in the image, the user will be able to click through to the website which uploaded the image and purchase the object. In this manner, the online index functions like an online marketplace. But such online marketplace functionality is not limited to the sale of material items. By creating an online index for the .cab and .taxi gTLDs, the index can consolidate data from multiple websites and/or apps used by taxi companies and independent drivers. Such websites and/or apps may utilize the template or plug-in, allowing users of the taxi cab index to facilitate the hiring of a taxi cab. Likewise, with websites or apps that offer dating, employment, online auctions, house and apartment rentals, hotel rooms, real estate, etc.

Use of the template and plug-in is not necessarily limited to websites using the new gTLD domain names and could instead be open to any website including those with .com, .net, .info and .org domain extensions. Additionally, the top level or parent directory of the online index may reside on the domain name https://www.indexter.com or https://www.index.org, etc.

One of the biggest problems facing online merchants is the cost they incur from third party payment processors for accepting online payments. The present invention solves this problem by utilizing a distributed ledger or block-chain to record the activity and transactions occurring on the index and the indexed websites. As such, the index will be able to create a decentralized exchange (or “DEX”) utilizing the hardware wallets of the users of the index, such as a USB device holding digital currency in memory. The hardware wallets run a software program to act like a decentralized exchange to enable payment transactions to be settled directly between buyers and sellers off-line and on a peer-to-peer basis bypassing any kind of third-party payment processor like a bank or a credit card processor that charges a fee for doing so. This ability will create a significant cost savings for any party accepting payment online and is yet another example of why the invention represents a unique and novel approach.

Additionally, utilizing a hardware wallet based DEX and a distributed ledger (or block chain) allows users of the index to enter into transactions anonymously without putting their personal or financial information at risk by having it stored on a website on which they make an online purchase. The purchase is settled off-line and peer-to-peer (between buyer and seller) on the DEX of each user's hardware wallet, recording it on the distributed ledger (or block chain) allowing the buyer to be issued a digital receipt that can be used to initiate a refund or return transaction.

The present invention (the “index”).

The claimed invention differs from what currently exists. Users of the world-wide-web must currently utilize algorithmic search engines, so called scraper sites like trivago.com or kayak.com or online ads to find relevant websites needed to fulfill their needs without having any way to evaluate such websites without visiting them first. This potentially exposes the user to malicious software code or incorrect or outdated content. These scraper sites do not utilize a template that links third party websites to their scraper website thus they do not make use of standardized tags or create a virtual database or link the websites to a distributed ledger, nor do they utilize the new gTLDs as an organizing nomenclature or reward users and websites for utilizing the index with dividends payable in the form of a digital currency, nor do they have the capability of settling transactions both off-line and peer-to-peer simultaneously by utilizing a DEX which operates on the hardware wallets of the users instead of computer servers connected to the internet.

The present invention also differs from other online marketplaces in that transactions may be settled anonymously, off-line and on a peer-to-peer basis between buyer and seller over a decentralized exchange or “DEX” operating on the hardware wallet of each user and utilizing a distributed ledger or block chain to record transaction histories. This will allow online merchants to bypass third party payment processors like banks and credit card payment processors allowing merchants to realize a significant savings in expensive transaction fees.

The present invention, a curated online index, leverages the intuitive nomenclature of the new gTLDs used by websites as a device to organize data/content such as images, contact information, consumer reviews, or prices into a global database that can be accessed by a single website or mobile user interface which can be used to facilitate trade.

For example, image gallery websites using the .gallery gTLD (or any website posting images online such as a catalogue) can use the template to feed their images and image descriptions to the online index so that users can view them and evaluate if they would like to purchase the product featured in the image. However, it is not necessary to for a third-party website to use the template to be listed on the index. For example, websites using the .directory gTLD such as insurance.directory can easily be located thanks to the site's use of the new .directory gTLD, then be evaluated and listed on the online index even if the developer of insurance.directory does not utilize the template. The online index is also not a single, or unitary, website like, for example, google.com or yahoo.com. The online index uses intuitive icon symbols placed in a bar at the top of a web browser and/or at the top of the website listed on the index. The icons will symbolize the subject areas of the index including, but not limited to, a “directory” icon to discover directory websites using the .directory gTLD such as insurance.directory, a “guide” icon to discover website guides using the .guide gTLD such as livemusic.guide, an image gallery icon to discover image gallery websites using the .gallery gTLD such as hair.gallery and car.gallery, and so forth.

When a user clicks on the icon, they are taken to the top-level index page for that subject area where they can search a keyword to discover a website or apps relevant to that keyword. For example when a user clicks on the directory icon, they will be taken to the top level directory index page where they can search the keyword “insurance” to reveal search results in the form of a list of sites that may include insurance.directory, lifeinsurance.directory, carinsurance.directory and so forth. If the user clicks on insurance.directory, for example, they will be taken to a top level search page where they can search for insurance agents by state, city, zip code, etc. while being able to view the index icons at the top of the page to easily navigate to other areas of the index.

All websites or apps listed on the index will be required to display the index icons at the top of the page being viewed on their site. No matter what page, website, or apps the user clicks through to, while visiting an index page or website or apps listed on the index the user will always be exposed to the index icons at the top of the page (or browser) so they can easily navigate to any subject area of index.

This invention is an improvement on what currently exists. The most popular internet search tools are algorithmic based search engines which rely on robotic software applications to find websites and use an algorithm to evaluate and rank the sites for relevance when a user initiates a search of the database using descriptive keywords.

These search engines seek to list every website on the internet, thus it is impossible for a human being to evaluate, or “curate”, all the websites found in the search engine's database. There is also no online index for sites using the new gTLD extensions which are still in their infancy. There are online marketplaces that attempt to consolidate content and product information from multiple websites using artificial intelligence, robotic software programs known as “bots”, so-called web crawling programs known as “spyders”, and mathematical algorithms. This method, known as “scraping”, frequently occurs without the knowledge or cooperation of the original publishers of the content and usually results in automated guesswork which may produce inaccurate results for the user such as incorrect images which do not match the search term, or inaccurate prices, or the display of products no longer in trade.

The method described herein utilizes a standardized method to tag data to produce the exact search results desired by the user. Data tags used by database programs are customized and defined each time a user creates a database, so such tags are not standardized across a broad spectrum of websites and apps. Utilizing a set of standardized data tags to define the data/content uploaded by the indexed websites and apps in a more descriptive fashion allowed by existing .html codes, in a fashion more appropriate for the typical user not well versed in computer code, is a key component of this novel approach to an online index. Also, the methodology of indexing websites and apps based on the intuitive domain name extensions of the new gTLDs that such websites and apps may be using is key to this novel approach.

By creating a template, such as a WordPress theme or plug-in, designed to be used by websites or apps utilizing the same domain name extension, such as .gallery for image galleries, or the same theme/subject/interest, then the data/content on these websites can be tagged using a standardized methodology that is more descriptive and useful to the typical user. This data/content may be consolidated into a single online index accessible to the user via a website or apps which allows for the creation of an online marketplace where transactions settle on a decentralized exchange or “DEX” operating off-line on each user's hardware wallet which are synchronized to the distributed ledger by the website/app template.

This facilitates trade, enabling the user to “shop” an unlimited number of websites simultaneously in a dramatically more efficient method than if the user was forced to locate the website using a search engine revealing thousands of options requiring the user to visit the most plausible options individually before finding the optimal one.

Both the template utilizing standardized descriptive data/content tags and the intuitive nature of the new gTLD nomenclature work together to enable a human curator to index the most relevant websites and apps for a given subject. This further establishes this intuitive nomenclature as a method of accessing content on the Internet without being dependent on algorithmic search engines that can easily be manipulated by developers using common “search engine optimization” techniques such as fabricated backlinks and content.

Additionally, by using the template, the index simultaneously creates: 1) A distributed ledger or “block chain” to record the transaction histories occurring on sites listed on the index; and, 2) A decentralized exchange or “DEX” which operates off-line by using the hardware wallets of the index users instead of computer servers connected to the internet to execute the DEX software program which settles transactions off-line. These hardware wallets are synchronized by the template using command prompts to receive innocuous, encoded payment data (“ghost payment”) instead of sensitive payment data such as identity/account information or digital currency keys which remain encoded in memory on the hardware wallet. The template acts like an escrow agent in between the hardware wallets of the counter-parties. The template software incorporates a “ghost cypher”, or code key, that allows it to see the ghost payment. The ghost payment is comprised of a buyer's hardware wallet reducing the amount of funds on it by the amount of the purchase price. This is done by the DEX software application operating on the processor constructed within the hardware wallet. Once the template views the ghost payment, it then gives permission to the DEX operating on the seller's hardware wallet to increase the funds on the wallet by the corresponding amount. The transaction is then then recorded on the block chain maintained by the template. The block chain may be used to evaluate and monitor the safety and security of the indexed sites and identify “bad actors” among the users.

Additionally, the distributed ledger creates the opportunity to reward users and website developers with a dividend payable in the form of a digital currency. The computing power of the users and websites can be leveraged each time a user initiates a command on an indexed website, such as initiating a search or transaction or clicking on an image, which can be made to create “hashing power” that can be utilized to mine a digital currency such as Bitcoin or Ethereum. The user and website can be rewarded with a dividend of digital currency based on the amount of hashing power contributed.

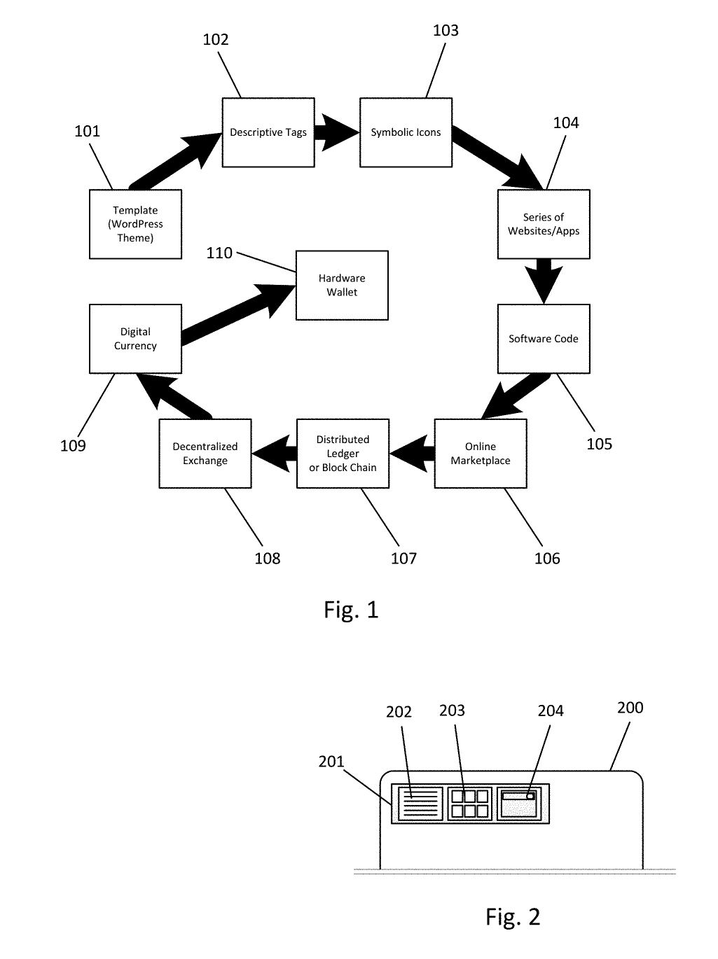

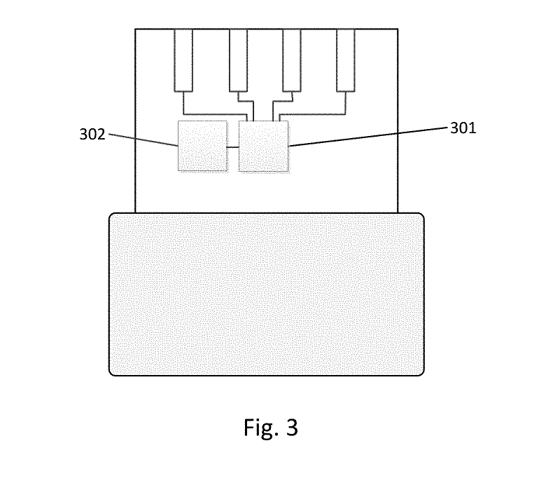

Turning now to FIGS. 1, 2, and 3 one embodiment of the present invention comprises the following elements:

1. A template 101 such as a WordPress theme or plug-in.

2. A standardized set of descriptive “tags” 102 for data and content.

3. A series of symbolic icons 103 reflecting new, intuitive gTLD extensions.

4. A series of websites or mobile software applications 104 or “apps”.

5. Software code 105.

6. An online marketplace 106.

7. An electronic, online distributed ledger 107 or “block chain”.

8. A decentralized exchange 108 or “DEX”.

9. A digital currency 109.

10. A USB hardware wallet 110.

Relationship between the components:

First, template 101 such as a WordPress theme or plug-in, is designed to be used specifically by websites utilizing the same domain name extension (but not necessarily), such as image galleries that use the .gallery domain extension. Next, template 101 utilizes standardized descriptive tags 102 to tag the data/content uploaded on to the site that makes all the data/content on all websites using template 101 compatible with, and able to function like, a single database. Next, this data/content may then be classified in an index and represented by symbolic icons 103 representing the particular classifications of the descriptive tags linked to the data/content. Symbolic icons 103 can be found grouped in an icon bar 201 on a web browser, website, or app running on a computer, telephone, or tablet 200. Next, by clicking a particular symbolic icon 103 (in this embodiment .directory icon 202, .gallery icon 203, or .guide icon 204) the user of the index can access the data/content online via a series of websites or apps 104 that utilize software code 105 which enables the user to query, filter, sort and display the data/content to the user without having to view multiple websites. This enables the series of websites or apps 104 to function as online marketplace 106. The user interacts with online marketplace 106 to shop for goods, services, or property utilizing a hardware wallet 110 constructed as a USB device. Next, in online marketplace 106, the transaction histories are recorded on electronic distributed ledger 107 or “block chain” as such term is used in the industry of digital currencies. This enables the creation of decentralized exchange 108 or “DEX” which utilizes the USB hardware wallet 110 of the user which includes a processor 301 to execute an exchange software program 302 in which users of the present invention settle payment transactions off-line and directly on a peer-to-peer basis without third parties like credit card payment processors or banks with the template acting like a payment escrow agent. The payments are managed using a digital currency 109 such as Bitcoin, Ethereum, or a proprietary currency.

The data uploaded by any website or apps that utilizes template 101 or plug-in, regardless of the domain extension used by that website or apps, can be consolidated by the index. It is not necessary for the website to use any specific type of domain name extension in order to be included on the online index. However, in addition to the use of standardized descriptive tags 102 for data and content, a primary purpose of the present invention is to leverage the new gTLDs into an intuitive index nomenclature to facilitate the creation of online marketplace 106. Thus any user looking for an insurance agent will intuitively know they can type “insurance.directory” into the address bar of their web browser and pull up an online directory of insurance agents which, by utilizing template 101, will feature a series of intuitive symbolic icons 103 at the top of the page that will allow the user to access other areas of the online index. For example the user will be able to click .directory icon 202 to be linked to the parent index web page listing more directory websites all using the .directory domain extension. Alternately, symbolic icons 103 can be linked to the parent index page of social media websites using the .social domain extension, etc. The online index template 101 will enhance the awareness and usefulness of the new gTLDs.

How the present invention works:

Template 101 is designed to be licensed specifically by third party website and apps developers utilizing the same domain name extension, such as image galleries that use the .gallery domain extension. Next, template 101 makes use of standardized descriptive tags 102 to tag the data uploaded to the site with its standardized list of tags that enables all the data on all websites using template 101 to function like a single database. Next, this data may be classified for an index using a series of symbolic icons 103 (in this embodiment .directory icon 202, .gallery icon 203, and .guide icon 204) each representing the index classifications of the data. For example, .directory icon 202 represents the data uploaded by directory websites using the .directory gTLD name such as insurance.directory, restaurant.directory, etc. Next, symbolic icons 103 are placed in icon bar 201 at the top or along the side of websites and/or web browsers the users of which will be able to click on symbolic icons 103 (in this embodiment .directory icon 202, .gallery icon 203, and .guide icon 204) in order to be linked to the index online via a broad range of websites or apps 104. Next, series of websites or apps 104 utilize software code 105 to allow the user to query, filter, sort, and display the results without having to view multiple websites. This enables the series of website or apps 104 to function as an online marketplace 106. Software code 105 is also used to create an electronic, online distributed ledger 107 or “block chain” that will record in an anonymous fashion all activity and all transactions occurring on series of website or app 104 utilizing template 101. From this is created a decentralized exchange 108 or “DEX”, which operates utilizing the USB hardware wallets 110 containing processor 301 executing exchange software program 302 of the index users instead of computer servers connected to the internet. USB hardware wallets 110 run the exchange software program to settle payment transactions anonymously, off-line, and on a peer-to-peer basis directly between buyer and seller without the use of a third-party payment processor such as a bank or credit card payment processor. The payments are made utilizing a digital currency 109 such as Bitcoin, Ethereum, or a proprietary currency.

How to make the present invention:

First, template 101, such as a WordPress theme or plug-in, (or a mobile software application commonly referred to as an “app”) is developed using software code and tools such as .net or php. Those having skill in the art will recognize that there are numerous equivalently acceptable development environments. Next, a standardized list of descriptive tags 102 that can properly identify the fine characteristics of the data uploaded using template 101 must be developed and incorporated into template 101. Software code is developed to consolidate the data from multiple websites utilizing template 101 into a virtual database as well as classify the data into an index. Next, a series of symbolic icons 103 representing the various index classifications based on selected gTLD domain extensions are defined. These symbolic icons 103 will need to be linked to a series of websites or apps 104, acting as parent directories for the index, making the index available to the public. Next, template 101 will create a horizontal (or vertical) icon bar 201 at the top (or side) of every series of websites or apps 104 utilizing template 101 which will display a series of symbolic icons 103 (in this embodiment .directory icon 202, .gallery icon 203, and .guide icon 204) symbolizing the gTLD domain extensions featured in the index, such as camera .guide icon 204 symbolizing gallery websites utilizing the .gallery domain extension.

How to use the present invention:

Someone using a web browser or apps will see a series of symbolic icons 103 (in this embodiment .directory icon 202, .gallery icon 203, and .guide icon 204) at the top of their browser or at the top of website page. The symbolic icons 103 may also be along one side of the browser or website page. The user can choose to access a specific classification of the index by clicking the corresponding icon. For example, a user choosing to view the index of online directories can click on the .directory icon 202 which will link the user to a web page that functions as the top-level index of directory websites where the user may type in a keyword to search for an online directory relevant to that keyword. For example, a user may type in “insurance” on the top level directory index page to view a list of directories related to the insurance industry such as insurance.directory, carinsurance.directory, lifeinsurance.directory, etc. The index will be “curated” so all directory websites using template 101 will be indexed and displayed according to their level of relevance to the keyword being searched. Thus insurance.directory will be displayed at the top level of the search results while sites like carinsurance.directory or lifeinsurance.directory will be displayed below insurance.directory. In addition to the directory, site developers using template 101, the insurance agents being listed on these insurance directories will also be able to use template 101 in order to be sure they are listed in all directory websites that use template 101 which may be relevant to their business. Thus, any insurance agent looking to be listed on insurance.directory, carinsurance.directory, lifeinsurance.directory, etc. may download template 101 to link their relevant information to these directories and be automatically listed.

As an example of how the technology may be used to create an online marketplace, a user trying to access an index of image galleries may click on image .gallery icon 203 to be linked to the top-level gallery index page. On this page, the user may either search a keyword such as “hair” in order to pull up the index of .gallery websites devoted to images of hair, or, alternately the user can click the image gallery icon next to the search bar to open up an image gallery that displays images of hair from all .gallery websites utilizing template 101 whose images are classified with hair related descriptive tags and can be easily searched by the user. The user may then browse images of any subject, such as dresses or autos, and click on an image for more details regarding a specific dress or auto before deciding to click through to the website displaying that image and purchase the dress or auto pictured.

It will be obvious to those having skill in the art that buyers and sellers may be represented in some transactions as lessors and lessees or renters and rentees. All such equivalent transactions are implicitly included in the present disclosure. Also, it will be understood to those having skill in the art, that USB hardware wallets may have other connectivity options. Specifically, USB connectivity may be replaced by other wired or wireless connectivity standards, including, but not limited to, Wi-Fi. All such equivalent wired or wireless connectivity standards are implicitly included in the present disclosure.

1. A system of indexing websites using contextually unique domain extensions comprising:
a. a template;
b. a standardized set of descriptive tags for data and content;
c. a series of symbolic icons reflecting gTLD extensions;
d. a group of user accessible software applications;
e. software code to consolidate the data from the multiple user accessible software applications utilizing the template into a virtual database and classify the data into an index;
f. an online marketplace comprising information presented by the user accessible software applications;
g. a distributed ledger or block chain that anonymously records all activity and all transactions occurring on any user accessible software;
h. a decentralized exchange operating on a hardware wallet enabling payment transactions to be settled off-line and peer-to-peer;
i. a digital currency.

2. A system of indexing websites using contextually unique domain extensions of claim 1 wherein the template is derived from a library of related code.

3. A system of indexing websites using contextually unique domain extensions of claim 1 wherein the template is a Java plug-in.

4. A system of indexing websites using contextually unique domain extensions of claim 1 wherein the template is an .html plug-in.

5. A system of indexing websites using contextually unique domain extensions of claim 1 wherein the user accessible software applications are websites.

6. A system of indexing websites using contextually unique domain extensions of claim 1 wherein the user accessible software applications are mobile software applications.

7. A system of indexing websites using contextually unique domain extensions of claim 1 wherein the user accessible software applications are apps.

8. A system of indexing websites using contextually unique domain extensions of claim 1 wherein the online marketplace is used to market goods.

9. A system of indexing websites using contextually unique domain extensions of claim 1 wherein the online marketplace is used to market services.

10. A system of indexing websites using contextually unique domain extensions of claim 1 wherein the online marketplace is used to market property.

11. A system of indexing websites using contextually unique domain extensions of claim 1 wherein the digital currency is Bitcoin.

12. A system of indexing websites using contextually unique domain extensions of claim 1 wherein the digital currency is Etherium.

13. A system of indexing websites using contextually unique domain extensions of claim 1 wherein the digital currency is proprietary currency.

14. A method of using a system of indexing websites using contextually unique domain extensions comprising the steps of:
a. seeing a series of index icons at the top of a user accessible software application;
b. choosing to access a classification of the index by clicking the corresponding index icon;
c. browsing the images of products displayed;
d. clicking on an image for more details regarding a specific product;
e. clicking through to the website displaying the product; and
f. purchasing the product.

15. A hardware wallet comprising:
a. a processor;
b. a software program; and
c. a communications facility;
d. wherein the software program implements a decentralized exchange and the wallet enables payment transactions to be settled off-line and peer-to-peer.
